(19) United States
(12) Patent Application Publication
(10) Pub. No.: US 2025/0093426 A1
(43) Pub. Date: Mar. 20, 2025

(54) METHOD FOR MONITORING AND TRACKING AN ELECTROCHEMICAL ENERGY STORE OF AN ELECTRICALLY DRIVABLE VEHICLE

(71) Applicant: Robert Bosch GmbH, Stuttgart (DE)

(72) Inventors: Christoph Woll, Gerlingen (DE); Martina Maurer, Rutesheim (DE)

(21) Appl. No.: 18/824,978

(22) Filed: Sep. 5, 2024

(30) Foreign Application Priority Data
Sep. 19, 2023 (DE) 10 2023 209 062.7

(51) Int. Cl. G01R 31/392; B60L 58/16; G01R 31/367; G01R 31/371; G01R 31/3842

(52) U.S. Cl. CPC G01R 31/392; B60L 58/16; G01R 31/367; G01R 31/371; G01R 31/3842

(57) ABSTRACT

A computer-implemented method for monitoring and tracking an electrochemical energy store of an electrically drivable vehicle.

### CROSS REFERENCE

The present application claims the benefit under 35 U.S.C. § 119 of German Patent Application No. DE 10 2023 209 062.7 filed on Sep. 19, 2023, which is expressly incorporated herein by reference in its entirety.

### FIELD

The present invention is based on a method, in particular a computer-implemented method, for monitoring and tracking an electrochemical energy store of an electrically drivable vehicle, to an apparatus for carrying out the method, and to a use of the method.

### BACKGROUND INFORMATION

In the future, more and more vehicles will be networked with one another, i.e., they will all be connected to one another via a cloud to which the data of the vehicles or of vehicle components will be transmitted.

The manufacturer and the vehicle owner can access these data. Algorithms use these data, for example to determine an aging state (SOH), a predicted aging state (SOH_{pred}), and/or to create a usage certificate.

For a networked, electrically drivable vehicle, for example a truck (“e-truck”), these data are likewise available in the cloud and are currently not used for any other purpose.

Electrically drivable passenger vehicles (“EVs”) usually do not require expensive battery replacement, unlike electrically drivable trucks, which put more stress on the battery due to a different usage mode and a different charging behavior, for example frequent rapid charging processes during the mandatory driving breaks, with the result that the battery ages much faster and may have to be replaced.

The information as to when and whether a replacement is due can be used by the repair shop for better planning the time at the repair shop, depending on the availability of a new battery as well, and by the shipping company for better cost planning, maximum utilization of the battery and of the electrically drivable truck. Such information in advance is in particular helpful for expensive components, such as the battery, or components that are not in stock.

German Patent No. DE 10 2020 201 697 B3 describes a method for categorizing a battery with regard to its suitability for further handling.

German Patent Application No. DE 10 2020 206 260 A1 describes a method and test system for checking a state of a battery in a vehicle.

It is an object of the present invention to further improve the related art. This object may be solved by certain features of the present invention.

### SUMMARY

According to an example embodiment of the present invention, the present invention with the characterizing features of the method comprises the following steps:
a) ascertaining a plurality of energy store characteristic variables, which comprise information about a usage mode of a prior use of the electrochemical energy store;
b) providing a usage certificate, which comprises at least one of the energy store characteristic variables;
c) storing the usage certificate in a database of a central unit;
d) providing a repair shop certificate, which comprises at least one of the ascertained energy store characteristic variables and represents a current state of the electrochemical energy store;
e) ascertaining a recommended course of action in the central unit on the basis of at least one of the ascertained energy store characteristic variables; and
f) providing the recommended course of action;

Advantageously, before a regular inspection of the electrically drivable vehicle, a vehicle owner, for example a freight forwarder, can retrieve the repair shop certificate, which contains meaningful energy store characteristic variables, and a recommended course of action.

Furthermore, the repair shop certificate can also indicate the temporal course of the charging behavior, in order to be able to make changes to the usage scenarios of the electrically drivable vehicle and of the resulting charging behavior, which can be crucial for the future use of the electrically drivable vehicle.

Subsequently, a recommended course of action is provided for the repair shop and the vehicle owner, for example whether a replacement of the electrochemical energy store is recommended at this time point, whether an inspection should be moved to an earlier or later time point since the predicted aging state of <80% and thus the remaining useful life of 0 km will then be reached at a later time point, for example, or whether the electrochemical energy store should not be replaced, since the electrically drivable vehicle is for sale. Furthermore, information is provided, which can also be used for better cost planning for the inspection.

Further advantageous embodiments of the present invention are disclosed herein.

The method according to an example embodiment of the present invention furthermore comprises the following step:
g) selecting an electrochemical energy store from a multitude of electrochemical energy stores on the basis of the recommended course of action, for replacing the electrochemical energy store of the electrically drivable vehicle.

The repair shop certificate and the recommended course of action are in particular helpful for a repair shop. Electrochemical energy stores are generally not components that a repair shop usually has in stock. On the one hand, they are very expensive components and, on the other hand, the components age over time in the warehouse. In addition, manufacturers or cell chemistry may change. By automatically selecting an electrochemical energy store on the basis of the recommended course of action, the electrochemical energy store can be ordered or produced in good time before the inspection date, so that availability is ensured and the inspection can be completed quickly, as a result of which the electrically drivable vehicle is quickly ready for use again.

According to an example embodiment of the present invention, the energy store characteristic variables comprise
a number of charging cycles, rapid charging cycles, full charging cycles and/or partial charging cycles that have already taken place,
a temperature and/or temperature fluctuations of the electrochemical energy store,
an electrical terminal voltage,
a level of charging currents and/or discharging currents,
an aging state (SOH),
at least one stress factor to which the electrochemical energy store was exposed,
a predicted aging state (SOH_{pred}) for at least one predetermined future time point,
identification information of the electrochemical energy store,
error memory entries, and/or
information on the remaining useful life and/or remaining useful distance
   of the electrochemical energy store.

Since a service life, and thus also the remaining useful life, of an electrochemical energy store decreases due to frequent rapid charging processes, which is in particular exacerbated further by charging processes in the megawatt range, this means that the electrochemical energy store more quickly reaches its aging state value of <80% and should be replaced.

Depending on the usage scenarios of the electrically drivable vehicle, for example long-distance traffic, local traffic, city traffic, a different number of rapid charging cycles is required.

On long routes, a charging process in the megawatt range during short breaks will become essential, whereas, on short routes, the electrochemical energy store will be gently charged almost exclusively overnight using moderate electrical currents. Consequently, the odometer mileage of the electrically drivable vehicle cannot be used as a relevant variable for replacing the electrochemical energy store.

According to an example embodiment of the present invention, for ascertaining the remaining useful life and/or remaining useful distance, an aging state determined by means of a data-based aging model is advantageously used to ascertain the recommended course of action for the electrochemical energy store in question.

Electrically drivable vehicles, in particular electrically drivable trucks, often drive similar or identical routes, both in long-distance traffic and in local traffic or city traffic. The load profiles with the operating variable curves are thus also very similar, which facilitates determination of the predicted aging state and leads to more precise results. This benefits a vehicle owner, in particular a freight forwarder, since they can use the repair shop certificate to estimate the remaining useful life and/or remaining useful distance more precisely.

A reliable statement can advantageously be made on the basis of energy store characteristic variables, such as aging state, predicted aging state, number of rapid charging cycles and further energy store characteristic variables.

According to an example embodiment of the present invention, the aging model comprises a probabilistic model, which in particular comprises at least one Gaussian process model, wherein an uncertainty of an aging state ascertained with the aging state model is determined.

Advantageously, according to an example embodiment of the present invention, an apparatus comprising at least one means is provided, in particular an electronic battery management control unit, which is configured to carry out the method according to the present invention.

According to an advantageous embodiment of the present invention, a computer program is provided, comprising instructions that cause the apparatus to perform the method steps of the method according to the present invention.

Furthermore, a machine-readable storage medium is provided, on which the computer program is stored.

Advantageously, the method according to the present invention for monitoring and tracking an electrochemical energy store is used for electric vehicles, fuel cell vehicles, hybrid vehicles, plug-in hybrid vehicles, pedelecs or e-bikes.

### BRIEF DESCRIPTION OF THE DRAWINGS

Exemplary embodiments of the present invention are illustrated in the figures and explained in more detail in the following description.

Further advantages and advantageous configurations of the subjects according to the present invention are illustrated by the figures and explained in the following description. It is to be noted that the figures are only descriptive in character and are not intended to limit the present invention in any way. Furthermore, the features described below may constitute an object of the present invention individually or in any combination, unless the context explicitly indicates the opposite.

FIG. 1 is a schematic representation of a decentral system of a vehicle fleet connected to an external central unit via communication connections, according to an example embodiment of the present invention.

FIG. 2 is a schematic representation of a functional structure of a hybrid aging state model, according to an example embodiment of the present invention.

FIG. 3 is a flow chart of an example embodiment of a method according to the present invention for monitoring and tracking an electrochemical energy store.

### DETAILED DESCRIPTION OF EXAMPLE EMBODIMENTS

In the figures, identical reference signs refer to identical apparatus components.

The method according to the presnet invention is described below on the basis of electrochemical energy stores in a multitude of electrically drivable vehicles as technical devices of the same type. In motor vehicles, a data-based aging state model for the respective electrochemical energy store can be implemented in a control unit. As described below, the aging state model can be continuously updated or retrained in an off-board central unit on the basis of the curves of operating variables and/or features of the electrochemical energy stores from the vehicle fleet. The aging state model is operated in the central unit and is used to calculate and predict aging.

The above example is representative of a multitude of stationary or mobile devices with a network-independent energy supply, such as vehicles (electric vehicles, pedelecs, etc.), systems, machine tools, household appliances, IoT devices, and the like, which are connected via a corresponding communication connection (e.g., LAN, Internet) to an external central unit (cloud).

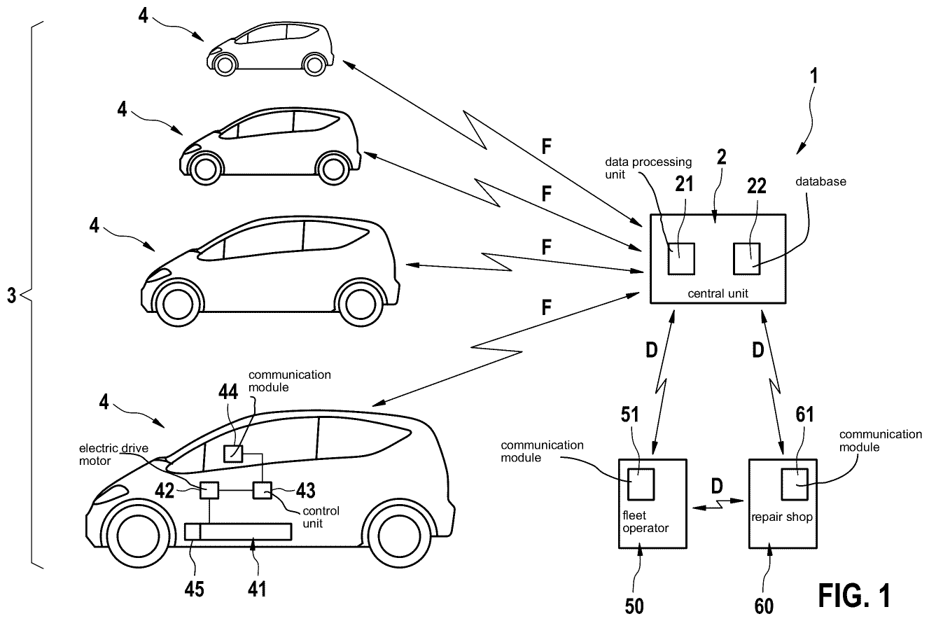

FIG. 1 shows a system 1 for collecting fleet data in a central unit 2 for creating and for operating as well as for evaluating an aging state model. The aging state model is used to determine an aging state of an electrochemical energy store 41 in a motor vehicle 4. FIG. 1 shows a vehicle fleet 3 having a plurality of motor vehicles 4.

One of the motor vehicles 4 is shown in more detail in FIG. 1. The motor vehicles 4 in each case comprise a rechargeable electrochemical energy store 41, an electric drive motor 42, and a control unit 43. The control unit 43 is connected to a communication module 44 which is suitable for transmitting data between the respective motor vehicle 4 and a central unit 2 (a so-called cloud). The electrochemical energy store 41 furthermore comprises a battery management system 45, which operates, continuously measures and monitors the electrochemical energy store 41. The battery management system 45 provides curves of operating variables, in particular of an electrical current, an electrical terminal voltage and a temperature of the electrochemical energy store 41.

The motor vehicles 4 send the operating variables F, which specify at least variables influencing the aging state of the electrochemical energy store 41, to the central unit 2. In the case of an electrochemical energy store 41, the operating variables F can comprise time series of an electrical current, an electrical voltage, a temperature and a state of charge (SOC) of the electrochemical energy store 41, at the pack level, module level and/or cell level. The operating variables F are captured in a fast time grid of 1 Hz to 100 Hz and can be regularly transmitted in uncompressed and/or compressed form to the central unit 2.

Furthermore, by utilizing compression algorithms for the purpose of minimizing the data traffic to the central unit 2 the time series can be transmitted to the central unit 2 in blocks at intervals of several hours to several days.

The central unit 2 has a data processing unit 21 in which the method described below can be executed, and a database 22 for storing data points, model parameters, states and the like.

An aging state model, which can be designed as a physical model or as a data-based hybrid or semi-hybrid model, is implemented in the central unit 2. The aging state model can be used regularly, i.e., for example, after the expiration of the corresponding evaluation period, in order to ascertain the current aging state of the electrochemical energy store 41 in question of the associated vehicle fleet on the basis of the time curves of the operating variables (in each case since the initial operation of the corresponding electrochemical energy store 41) and operating features ascertained therefrom. In other words, it is possible to ascertain an aging state of the electrochemical energy stores 41 in question on the basis of the curves of the operating variables of one of the electrochemical energy stores 41 of the motor vehicles 4 of the associated vehicle fleet 3 and the operating features that result or are determined from these curves of the operating variables.

The aging state (state of health, SOH) is the key variable for specifying a remaining capacity of the electrochemical energy store 41 or a remaining charge. The aging state represents a measure of the cyclic aging that goes beyond the chronological aging of the electrochemical energy store 41 or of a module or of a cell and can be specified as the capacity retention rate (SOH-C) or as the increase in internal resistance (SOH-R). The capacity retention rate SOH-C is specified as the ratio of the measured current capacity to a starting capacity of the fully charged electrochemical energy store 41. The relative change in the internal resistance SOH-R increases with increasing aging of the electrochemical energy store 41.

A fleet operator 50, for example a shipping company, or a driver, vehicle owner, and/or a repair shop 60 can communicate with the central unit 2 and/or with one another via a data connection D by means of a communication module 51 or 61.

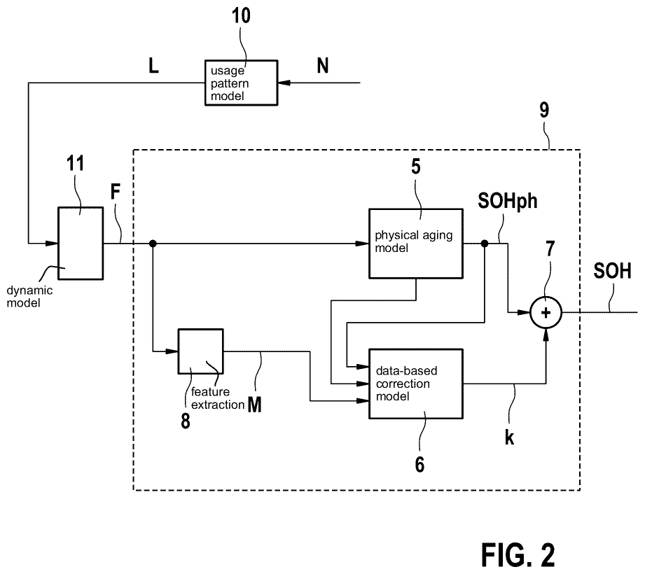

FIG. 2 shows an example of a functional structure of an embodiment of a hybrid aging state model 9, which has a physical aging model 5 and a data-based correction model 6. These models obtain operating variables F or operating features M of a current evaluation period/aging time point (age of the electrochemical energy store 41 since the time point of initial operation). The operating features M of the current evaluation period/aging time point are generated in a feature extraction block 8 on the basis of the time series of the operating variables F.

The physical aging model 5 is a nonlinear mathematical model based on differential equations. Such a model is conventional in the related art and makes it possible to determine a corresponding physical aging state SOHph by evaluating differential equations, which the electrochemistry of the electrochemical energy store 41 in relation to aging-relevant model parameters by extrapolating the state on the basis of the operating variable curves (from the time point of initial operation or a time point at which the internal state is known, up to the current time point or evaluation period to be considered). The evaluation of the physical aging model 5 of the aging state model 9 with operating variable curves F, in particular since the beginning of the service life of the electrochemical energy store 41, results according to the time integration method in an internal state of the system of physical differential equations that corresponds to a physical internal state of the electrochemical energy store 41.

Since the physical aging model 5 is based on physical and electrochemical principles, the internal states of the physical aging model comprise variables specifying physical properties, such as an equilibrium potential for an anode side reaction, a transfer coefficient for the anode side reaction with a first electrolyte, an anode polarization factor, an SEI conductivity, a deposition rate, an equilibrium potential for a cathode side reaction, a side reaction rate at the cathode, a current-dependent coefficient of mechanical stress in the active material of the anode, a weighting for the capacity loss due to loss of active material and the like. The internal states can be used to provide the physically based aging state SOHph in the form of a capacity retention rate (SOH-C) and/or an internal resistance increase rate (SOH-R) as linear or nonlinear mapping of the internal states.

However, the model values that the physical aging model 5 provides for the physical aging state SOHph are inaccurate in certain situations, and it is therefore provided to correct them with a correction variable k. The correction variable k is provided by the data-based correction model 6.

For the determination of a corrected aging state SOH to be output, the outputs SOHph and k of the physical aging model 5 and of the correction model 6, which is preferably designed as a Gaussian process model, are applied together. In particular, they can be added or multiplied (not shown) in a summing block 7, in order to obtain the modeled aging state SOH to be output for a current evaluation period or aging time point. In the case of addition, the confidence of the Gaussian process can furthermore be used as the confidence of the corrected aging value SOH to be output by the hybrid model.

On the input side, the correction model 6 receives operating features M, which can be ascertained from the curves of the operating variables F and can also comprise one or more of the internal electrochemical states of the differential equation system of the physical aging model.

Furthermore, the correction model 6 can receive on the input side the physical aging state SOHph obtained from the physical aging model 5. The operating features M of the current evaluation period are generated in a feature extraction block 8 on the basis of the time series of the operating variables F. The operating features M furthermore include the internal states from the state vector of the electrochemical physical aging model 5 and, advantageously, the physical aging state (SOHph).

The operating features M can, for example, comprise features relating to the evaluation period and/or accumulated features and/or statistical variables ascertained over the entire previous service life. In particular, features from histogram data that were created from the curves of the operating variables can be ascertained as operating features. For example, histograms with respect to the electrical current over the temperature and the state of charge of the electrochemical energy store 41, a histogram of the temperature over the state of charge of the electrochemical energy store 41, a histogram of the electrical current over a temperature and a histogram of a discharge current over the temperature of the electrochemical energy store 41 can be created. Furthermore, the accumulated total charge (Ah), an average capacity increase during a charging process (in particular for charging processes with which the charge increase is above a threshold fraction [e.g., 20% ΔSOC] of the total capacity of the electrochemical energy store 41), the charging capacity as well as an extreme value (e.g., a local maximum) of the smoothed differential capacity during a measured charging process with sufficiently large stroke of the state of charge (smoothed curve of dQ/dU: charge change divided by change in the electrical voltage of the electrochemical energy store 41) or the accumulated mileage, in each case since the initial operation of the electrochemical energy store 41, can be taken into account as operating features.

These variables are preferably converted such that they optimally characterize the real usage behavior, and are standardized in the feature space. The operating features M can be used altogether or only in part for the method described below.

Other embodiments of the hybrid aging state model are likewise possible; for example, the hybrid aging state model can be designed as a non-hybrid, purely data-based model based on a probabilistic or an artificial-intelligence-based regression model, in particular a Gaussian process model, or a Bayesian neural network. The latter is trained to provide a modeled aging state SOH from an operating feature point determined by current operating features M of the current evaluation period/aging time point, wherein the operating features M are ascertained in a feature extraction block 8 on the basis of the time series of the operating variables F.

The operating features M and also further operating features that are generated in the feature extraction block 8 can also be fed to the data-based correction model 6, which is preferably designed as a Gaussian process model. A reduction of the feature space, especially with the aid of a principal component (PCA) transformation, is advantageously upstream of the data-based correction model. The data-based correction model 6 serves to provide a correction variable k for applying the physical aging state ascertained by the physical aging model, in order to obtain a corrected aging state SOH for the time point considered. The data-based correction model 6 is trained on the residual of the physical aging model 5 and trained and validated with real measured aging states as labels.

Furthermore, in the data-based correction model 6, electrochemical states resulting from the evaluation of the hybrid aging model for an aging state can be taking into account as input variables. Electrochemical states can, for example, comprise one or more of the following variables: an SEI layer thickness, a change in cyclable lithium due to anode/cathode side reactions, a rate of rapid intake of electrolyte solvents, a rate of slow intake of electrolyte solvents, a rate of lithium deposition, a loss of active anode material and a loss of active cathode material, as well as information on impedances or the internal resistances.

The aging state model 9 can be applied in the central unit 2, wherein operating variable curves F of the individual vehicles 4 are transmitted to the central unit 2. Alternative embodiments can provide that the aging state model 9 is applied in the vehicle by transmitting corresponding model parameters to the vehicle.

An alternative model for determining an aging state of the electrochemical energy store 41 as a state can form an electrochemical performance model, which is parameterized by a parameter fit with at least one equilibrium parameter and at least one kinetic model parameter. The performance model includes the electrical current and the temperature as operating variables and makes it possible to ascertain a resulting voltage, a state of charge and an open-circuit voltage characteristic curve. They make it possible to calculate an aging state as a state.

As described above in connection with the use of the hybrid model, operating features, some of which can be determined as stress factors, can be derived from the operating variable curves. For example, the frequency of rapid charging processes, a temperature curve of the temperature of the electrochemical energy store 41, the average ampere-hour throughput during driving operation and the like can be defined as stress factors.

The calculation of the aging state, and in particular the tracking of the course of the aging behavior of the electrochemical energy store 41 in question, also makes it possible to predict the aging state for a predetermined prediction horizon, such as five months. Both the calculation and the prognosis of the aging state can in each case be provided with confidence information, wherein the uncertainty or confidence is calculated with the aid of the probabilistic correction model, advantageously with the Gaussian process model. This uncertainty, inter alia, also represents, the remaining technical risk of a buyer when executing a smart contract.

A prediction of the aging state for the predetermined prediction horizon can take place in various ways and can, for example, be based on extrapolation methods. One possibility described below is to predict operating variable curves on the basis of specified usage patterns, which curves can be used to determine predicted aging states. However, this possibility is only an example and there are numerous further possibilities in the related art to determine predicted aging states starting from a current aging state on the basis of a specified usage pattern.

For predicting a future aging state progression, a dynamic model 11 is used to generate time curves of operating variables F, such as the electrical voltage U and the state of charge SOC, on the basis of a curve of at least one load variable, such as the curve of the electrical current I and the temperature T, and to provide all these operating variables F, namely, the time curves of the electrical voltage U, the state of charge SOC, the electrical current I and, if applicable, the temperature T, altogether as “artificial” operating variable curves to the hybrid aging state model. For electrochemical energy stores 41, the curves of the generated load variables thus correspond to a part of the “artificial” operating variable curves.

The dynamic model 11 thus has the task of providing (non-real, artificially generated) time series or curves of load variables, which were generated for the hybrid aging state model in the prediction case, for the creation of operating variables F and/or as at least a part of the operating variables F, with which a prediction of the progression of the aging state can be carried out by extrapolating the current aging state (on the basis of the curves of the operating variables F that have been captured since the beginning of the service life (initial operation)). For example, a voltage response can be provided by the dynamic model after current and temperature have been applied to the dynamic model on the input side. Temperature curves and current curves can be learned individually for each driver from historical data and used for future predictions.

The dynamic model 11 can be designed in various ways, such as an equivalent circuit model, an electrochemical model, a single particle model of electrochemical energy storage cells or the like. The dynamic model 11 can in particular correspond to an electrochemical energy store model that models equilibrium states and calibrates itself on the basis of cell voltages during rest phases in order to generate an electrical current and state of charge from an electrical voltage. Alternatively, the dynamic model can be designed as an energy store performance model for characterizing the system transfer function, wherein the nonlinearity of the current intensity is eliminated via Butler-Volmer tuning.

The generation of the operating variable curves from the curves of the load variables can take place depending on the resulting aging state SOH of the electrochemical energy store 41 and causes the dynamic model 11 to be updated, especially with respect to its parameters or alternatively its states. The transfer behavior of the dynamic model 11 thus changes depending on the aging state of the electrochemical energy store 41. Typically, this parameter update takes place once per (simulated) month during a simulation or prediction.

The aging state SOH is taken into account by updating either parameters and/or states of the dynamic model 11 on the basis of the calculated modeled aging state SOH.

In order to generate the curves of the load variables for the prediction of the aging state, a usage pattern model 10 is provided. The usage pattern model 10 converts specified user-specific usage patterns N into curves of load variables that reflect the load on the energy store 41 to which the energy store 41 is exposed in the usage mode and operating mode specified by the usage pattern. The usage patterns N thus lead to the output of a time curve of an electrical current I and a temperature T as load variables L by the usage pattern model 10, with which the set of operating variables F with the curves of the electrical voltage U and the state of charge SOC is completed with the aid of the dynamic model 11, in order to generate the artificially generated curves of the operating variables F.

The usage patterns can be defined by usage parameters N, which are learned individually for each user by the usage pattern model 10, preferably with the aid of data-based methods, and serve to simulate the usage behavior of a user or of a drive train with respect to the electrochemical energy store 41 in question.

The usage pattern model can be designed as a recurrent neural network, such as an LST or GRU, in particular as a Bayesian LSTM network, and trained on the basis of curves of load variables or operating variables F, which specify a usage mode of the energy store 41. The curves of load variables or operating variables F to be taken into account should be based on a period of the same usage mode and the same operating mode of the electrochemical energy store 41.

The usage parameters N, which specify the usage pattern, then correspond to the model parameters of the usage pattern model, i.e., in the case of a neural network, to the weights and bias values of the individual neurons. Furthermore, prior and posterior distributions as well as probabilities conditioned on observations according to Bayes' theorem can be taken into account as relevant parameters.

The usage patterns can result by training the usage pattern model on the basis of known time curves of the load variables and/or the operating variables F with respect to their chronological reference and with respect to a particular user. That is, the usage pattern model is trained on the input side with chronological time information and on the output side with the load variables (current, temperature, preferably as a time series) and/or the operating variables F in a conventional manner for recurrent neural networks. By specifying chronological time information, such as the date and time, an artificial curve of the load variables and/or the operating variables F can be generated. The chronological time information can also contain the day of the week, the month and knowledge of public holidays and can in particular take seasonality into account through feature engineering.

The usage pattern model 10 can thus be trained directly from raw data of the curves of the load variables L and/or the operating variables F. For the electrochemical energy store 41, typical patterns of the current profile, e.g., due to recurring commuter routes and typical idle times and rest times and loads with respect to temperature ranges, are thus recognized and made reproducible.

The usage parameters can alternatively also be load parameters, which, for example, may characterize the usage mode and/or operating mode of the electrochemical energy store 41 and correspond to statistically captured variables.

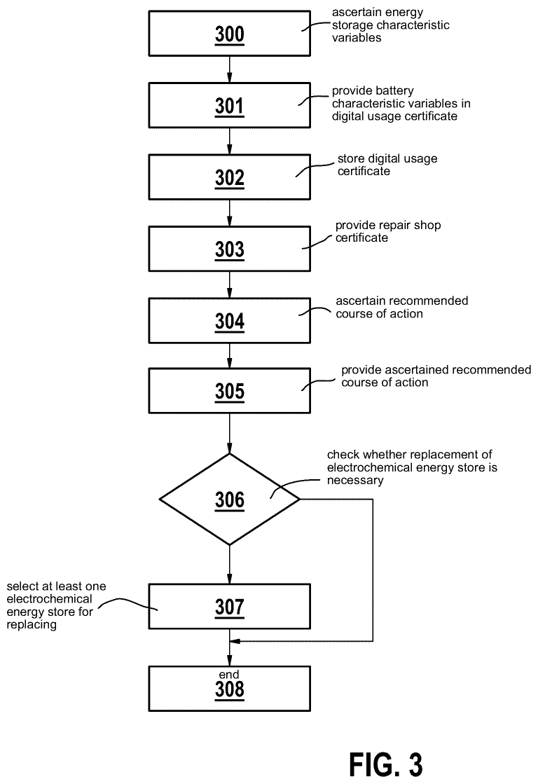

In connection with the flow chart of FIG. 3, a method for monitoring and tracking an electrochemical energy store 41 is described.

In step 300, a plurality of energy store characteristic variables, which comprise information about a usage mode of a prior use of the electrochemical energy store 41, is ascertained. By evaluating the historical operating variable curves, a number of energy store characteristic variables is obtained, which specify a number of charging cycles, rapid charging cycles, full charging cycles and/or partial charging cycles that have already taken place, a temperature and/or temperature fluctuations of the electrochemical energy store 41, an electrical terminal voltage, a level of charging and/or discharging currents, an aging state (SOH) of the electrochemical energy store 41, stress factors to which the electrochemical energy store 41 in question was exposed, a predicted aging state for at least one predetermined future time point (at least one prediction horizon), error memory entries and/or information on the remaining useful life and remaining useful distance as characteristic variables for the individual electrochemical energy store 41.

In step 301, the battery characteristic variables thus ascertained are provided in a digital usage certificate.

In step 302, the digital usage certificate for the individual electrochemical energy store 41 is stored. In particular, at least one state can be stored together with the confidence. The digital usage certificate can additionally contain information about the electrically drivable vehicle 4, including unique identification information about the electrically drivable vehicle 4, such as an identification number of the electrochemical energy store 41 or, alternatively, a vehicle identification number, a total mileage, date of manufacture and the like, and supplement this information with the information about the electrochemical energy store 41 used therein, including an identification number, service life (chronological age), nominal data, such as storage capacity, date of manufacture as well as the ascertained characteristic variables of the electrochemical energy store 41. Furthermore, cumulative stress factors or time series progressions of stress factors, such as load histograms, can be stored. Specifically, these can correspond to the operating features of the hybrid aging state model.

The thus ascertained usage certificate, which at least partially comprises the information described above, is stored in step 302 in encrypted form, in particular with the aid of a private key/public key concept.

If a driver of the electrically drivable vehicle 4 is now shown in a cockpit instrument that, for example, an inspection of the electrically drivable vehicle 4 is due within 30 days or 10,000 km, a fleet operator 50 can schedule a “suitable” appointment with a repair shop 60 via the data connection D.

In step 303, a repair shop certificate is provided, which comprises at least one of the ascertained energy store characteristic variables and represents a current state of the electrochemical energy store 41.

The fleet operator 50 can connect to the central unit 2 via the secure data connection D. Furthermore, they can transmit data, for example a vehicle identification number, to the central unit 2. The central unit 2 provides the repair shop certificate to the fleet operator 50 via the data connection D. The repair shop certificate for the fleet operator 50 comprises energy store characteristic variables in a processed form as well as past operating variable curves, error memory entries, and specific information on the remaining useful life.

The repair shop certificate can provide different representations for the fleet operator 50 and the repair shop 60, since different energy store characteristic variables are relevant for them. For example, fleet operators 50 may primarily be interested in the questions “How long can the vehicle still drive with this battery?” and “How many kilometers can the vehicle still travel with this battery?” The fleet operator is then provided with the energy store characteristic variables “remaining useful life” and “remaining useful distance.”

All other energy store characteristic variables are of little use to the fleet operator 50, but they are relevant for the repair shop 60, since they can be correctly interpreted and analyzed by the repair shop personnel. These energy store characteristic variables can be presented in tabular and/or graphical form. Advantageously, the energy store characteristic variables can be transmitted to a repair shop test device.

In step 304, a recommended course of action is ascertained in the central unit 2 on the basis of at least one of the ascertained energy store characteristic variables.

In step 305, the ascertained recommended course of action is provided.

On the basis of the available data and the recommended course of action, the fleet operator 50 can decide when they want to perform the inspection in connection with or without a replacement of the electrochemical energy store 41, in particular depending on the age of the electrically drivable vehicle 4 and the routes it has traveled and is to travel in the future.

In step 306, on the basis of the recommended course of action, it is checked whether a replacement of the electrochemical energy store 41 is necessary. If a replacement is not necessary, the method continues in step 308.

Depending on the estimated time point for reaching the remaining useful life and remaining useful distance of the electrochemical energy store 41, the starting conditions for the inspection, the availability of the electrically drivable vehicle 4, a maximum utilization of the storage capacity of the electrochemical energy store 41, deadlines, order situation, financial situation and/or usage scenarios, they decide when the electrically drivable vehicle 4 has to be available for an inspection with/without replacement of the electrochemical energy store 41 and the work should be carried out.

The fleet operator 50 sends a suggested appointment via the data connection D to the repair shop 60, which retrieves the repair shop certificate and the recommended course of action before a repair shop visit. All energy store characteristic variables are available to the repair shop 60. Relevant for the repair shop 60 are not only the remaining useful life and remaining useful distance, but also the number of rapid charging cycles, in order to be able to recognize therefrom an increased aging of the electrochemical energy store 41, which is crucial for the future use of the electrically drivable vehicle 4; the aging state; the predicted aging state; electrical voltage curves, which provide indications of lithium plating, in particular due to rapid charging processes, or deep discharging or constant full charging; as well as further relevant energy store characteristic variables, in order to have all necessary replacement components on site when the electrically drivable vehicle 4 comes to the repair shop, so that the work can be completed as quickly as possible and the electrically drivable vehicle 4 is available again to the fleet operator 50 or freight forwarding company.

As a result, the current status, in particular of the electrochemical energy store 41, is already known before the electrically drivable vehicle 4 arrives. Reading out the error memory can be omitted since the repair shop 60 is already prepared for the work to be carried out on the vehicle 4 and the electrochemical energy store 41.

In step 307, at least one electrochemical energy store from a multitude of electrochemical energy stores is selected on the basis of the recommended course of action, for replacing the electrochemical energy store 41 of the electrically drivable vehicle 4 depending on the comparison.

The method ends in step 308.

What is claimed is:

1. A computer-implemented method for monitoring and tracking an electrochemical energy store of an electrically drivable vehicle, comprising the following steps:
a) ascertaining a plurality of energy store characteristic variables, which include information about a usage mode of a prior use of the electrochemical energy store;
b) providing a usage certificate, which includes at least one of the energy store characteristic variables;
c) storing the usage certificate in a database of a central unit;
d) providing a repair shop certificate, which includes at least one of the ascertained energy store characteristic variables and represents a current state of the electrochemical energy store;
e) ascertaining a recommended course of action in the central unit based on at least one of the ascertained energy store characteristic variables; and
f) providing the recommended course of action.

2. The method according to claim 1, further comprising the following step:
g) selecting an electrochemical energy store from a multitude of electrochemical energy stores based on the recommended course of action, for replacing the electrochemical energy store of the electrically drivable vehicle.

3. The method according to claim 1, wherein the energy store characteristic variables include:
a number of charging cycles and/or rapid charging cycles and/or full charging cycles and/or partial charging cycles that have already taken place, and/or
a temperature and/or temperature fluctuations of the electrochemical energy store, and/or
an electrical terminal voltage, and/or
a level of charging currents and/or discharging currents, and/or
an aging state, and/or
at least one stress factor to which the electrochemical energy store was exposed, and/or
a predicted aging state for at least one predetermined future time point, and/or
identification information of the electrochemical energy store, and/or
error memory entries, and/or
information on a remaining useful life and/or remaining useful distance of the electrochemical energy store.

4. The method according to claim 1, wherein an aging state determined using a data-based aging model is used to ascertain a remaining useful life and/or remaining useful distance, in order to ascertain the recommended course of action for the electrochemical energy store.

5. The method according to claim 4, wherein the aging model includes a probabilistic model, which includes at least one Gaussian process model, wherein an uncertainty of an aging state ascertained with the aging state model is determined.

6. An apparatus, comprising:
an electronic battery management control unit configured to monitor and track an electrochemical energy store of an electrically drivable vehicle, the electronic battery management control unit configured to:
a) ascertain a plurality of energy store characteristic variables, which include information about a usage mode of a prior use of the electrochemical energy store;
b) provide a usage certificate, which includes at least one of the energy store characteristic variables;
c) store the usage certificate in a database of a central unit;
d) provide a repair shop certificate, which includes at least one of the ascertained energy store characteristic variables and represents a current state of the electrochemical energy store;
e) ascertain a recommended course of action in the central unit based on at least one of the ascertained energy store characteristic variables; and
f) provide the recommended course of action.

7. A non-transitory machine-readable storage medium on which are stored instructions for monitoring and tracking an electrochemical energy store of an electrically drivable vehicle, the instructions, when executed by a data processing device, causing the data processing device to perform the following steps:
a) ascertaining a plurality of energy store characteristic variables, which include information about a usage mode of a prior use of the electrochemical energy store;
b) providing a usage certificate, which includes at least one of the energy store characteristic variables;
c) storing the usage certificate in a database of a central unit;
d) providing a repair shop certificate, which includes at least one of the ascertained energy store characteristic variables and represents a current state of the electrochemical energy store;
e) ascertaining a recommended course of action in the central unit based on at least one of the ascertained energy store characteristic variables; and
f) providing the recommended course of action.

8. The method according to claim 1, wherein the method is used for monitoring and tracking the electrochemical energy store for an electric vehicle or a fuel cell vehicle or a hybrid vehicle, or a plug-in hybrid vehicle or a pedelec or an e-bike.
